(19) United States
(12) Patent Application Publication
(10) Pub. No.: US 2005/0036241 A1
(43) Pub. Date: Feb. 17, 2005

(54) Rotary disk storage device and method

(75) Inventors: Shingo Tsuda, Kanagawa (JP); Yasunori Kawamoto, Kanagawa (JP); Tsuyoshi Matsumoto, Kanagawa (JP); Taichi Nakamura, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Netherlands, B.V., Amsterdam (NL)

(21) Appl. No.: 10/890,302

(22) Filed: Jul. 12, 2004

(30) Foreign Application Priority Data
Aug. 15, 2003 (JP) 2003-293721

(51) Int. Cl. G11B 5/55

(52) U.S. Cl. 360/264

(57) ABSTRACT

Embodiments of the invention provide a rotary disk storage device in which dust particles are less likely to deposit on the air bearing surface of each head/slider. The actuator head suspension assembly is configured so as to make the skew angle of the head/slider positive at about 80% or more of all the tracks. Specifically, the actuator head suspension assembly is configured in such a manner that the distance L2 between the center of the pivot shaft and the intersection point P of the trailing edge of the head/slider is made longer than a given length or there is an angle β between the reference line Y and the pivot line Z.

### BACKGROUND OF THE INVENTION

The present invention relates to magnetic disk devices, optomagnetic disk devices and other rotary disk storage devices provided with a head/slider, and in particular, to a rotary disk storage device which is structured so as to reduce the deposition of dust on the air bearing surface of its head/slider.

In a magnetic disk device, air flow which occurs over the surface of a rotating magnetic disk is guided to the air bearing surface of a head/slider to generate buoyancy which lifts up the head/slider a little from the magnetic disk surface. When data is read/written from/to the magnetic disk, the head/slider is flying in this manner. The spacing kept between the head and the magnetic disk surface must be made as constant as possible since the strength of magnetic coupling between them is affected by the spacing. Further, due to the recent particular tendency for the head/slider to reduce its flying height in step with the rising recording density, it is required to more accurately control the flying height in order to prevent contact between the magnetic disk and the head/slider.

While positive buoyancy acts on the air bearing surface of the head/slider opposed to the magnetic disk surface to raise the head/slider apart from the magnetic disk surface, the head/slider receives a negative pressing load toward the magnetic disk surface by a suspension assembly which supports the head/slider. Its flying height settles to a level where the two forces balance with each other. The recording surface of the magnetic disk has a plurality of tracks which are concentric recording regions formed around the spindle shaft. Once the head/slider is positioned to an appointed track, it can read/write data from/to the sectors formed along the circular track by accessing the sectors sequentially.

The magnetic disk has concentric tracks formed continuously from the innermost to outermost tracks. The speed of air flow that occurs over the recording surface changes depending on the distance from the center of the spindle. This changes the buoyancy that acts on the air bearing surface, i.e., makes the flying height dependent on the linear speed of the track. Further, during seek operation, there is a possibility that the flying stability may be lost since the buoyancy dynamically changes. To maintain the flying stability for all tracks, the air bearing surface of the head/slider has a sophisticated shape formed accurately. Thus, the shape of the air bearing surface must be maintained strictly over a long period of time.

Meanwhile, a head disk assembly (HDA) comprises magnetic disks, an actuator mechanism, and a spindle drive mechanism. The components that constitute the HDA go through a washing process with ultrapure water and a drying process with clean air before they are assembled into the casing in a clean room in order to prevent dust from penetrating into the HDA. In the assembling process, however, a small amount of dust is inevitably introduced. In addition, it is possible that the head/slider touches the recording surface of the magnetic disk if vibrations or shocks are given from the external. In the assembled HDA, this may cause a dust-generating source. Further, it is possible that dust penetrates into the HDA through a filter that separates the HDA from the external environment.

Dust in the HDA flows between the air bearing surface of the head/slider and the recording surface of the magnetic disk together with flowing air that occurs over the recording surface. We observed the air bearing surface of a head/slider whose flying performance was deteriorated in a long used magnetic disk device and found that the dust-deposited air bearing surface had apparently changed from the initial shape. The causes of the deposited dust may include the viscous component of the lubricant which is used to coat the recording surface of the magnetic disk in order to prevent the head/slider from being damaged when the flying head/slider happens to touch the recording surface due to shocks or the like.

A head/slider capable of vaporizing fluids, such as a lubricant, and foreign viscous particles stuck to the air bearing surface is disclosed in, for example, Japanese Patent Laid-open No. 8-279120.

Further, a technique for preventing the slider and magnetic disk from being damaged by accumulating and penetrating dust and other foreign particles is disclosed in, for example, Japanese Patent Laid-open No. 2001-266323. In this method, each sidewall of the outflow pad on the slider is designed to have a certain angle.

However, the prior art methods cannot satisfactorily suppress the deposition of dust particles on the air bearing surface of the head/slider. The flying height of the head/slider is getting lower in step with the rising recording density. In this situation, magnetic disk devices are required in structure to more securely suppress deposition of dust particles.

### BRIEF SUMMARY OF THE INVENTION

Embodiments of the present invention provide a rotary disk storage device, such as a magnetic disk device or optomagnetic disk device, which can suppress deposition of dust particles on the air bearing surface of each head/slider, as well as a method for suppressing deposition of dust particles on the bearing surface of the head/slider in a rotary disk storage device.

Knowing that dust deposition on the air bearing surface of a head/slider is attributable to the skew angle of the head/slider which changes between positive and negative values while the storage device is operating, that is, to the direction of air entering the leading edge which changes across the perpendicular direction, a feature of the present invention is to configure the device so as not to cause the sign of the skew angle to change. More specifically, the device is configured in such a manner that the skew angle is made substantially always positive or negative in order to prevent the air flow direction from changing across the perpendicular direction.

According to a first aspect of the present invention, there is provided a rotary disk storage device comprising: a rotary disk type recording medium which is rotatably held around a spindle and has a plurality of concentric tracks around the spindle; and a head/slider. The head/slider includes a head; and a slider having a leading edge, a trailing edge, and an air bearing surface. A reference line Y perpendicular to the leading edge and a point P where the reference line Y intersects the trailing edge are defined. An actuator suspension assembly is mounted with the head/slider thereon and is swung around a pivot shaft to position the head/slider to an appointed track of the plurality of tracks. A distance L1 between the center of the pivot shaft and the center of the spindle and a distance L2 between the center of the pivot shaft and the point P are defined. The actuator suspension assembly is configured so as to make the skew angle of the head/slider positive with respect to the rotary disk type recording medium at about 80% or more of all the plurality of tracks.

If the skew angle of the head/slider is made positive at about 80% or more of all the plurality of tracks, air flows at positive skew angles have substantially larger influence than air flows at negative skew angles. In this case, if dust particles are accumulated on the air bearing surface, they may be quickly or slowly removed by moving air, resulting in the reduced amount of deposition. To effectively prevent the dust deposition, the skew angle of the head/slider is made positive more preferably at about 90% or more and most preferably at 100% of all the plurality of tracks.

In the case of a rotary actuator, if the head/slider is swung in the radial direction of the recording medium with the distance L2 between the center of the pivot shaft and the point P being fixed, the skew angle becomes larger in the negative direction as the head/slider moves to inner tracks while the skew angle becomes larger in the positive direction as the header/slider moves to outer tracks. If the same track is accessed, making the distance L2 between the center of the pivot shaft and the point P longer changes the skew angle larger in the positive direction while making the distance L2 shorter changes the skew angle larger in the negative direction.

Thus, if the reference line Y is aligned with the pivot line Z, the skew angle of the head/slider can be made positive at an appointed percentage of all tracks by setting the distance L2 appropriately with respect to the appointed percentage of all tracks.

According to a second aspect of the present invention, there is provided a rotary disk type recording medium which is rotatably held around a spindle and has a plurality of concentric tracks around the spindle; and a head/slider. The head/slider includes a head; and a slider having a leading edge, a trailing edge, and an air bearing surface. A reference line Y perpendicular to the leading edge and a point P where the reference line Y intersects the trailing edge are defined. An actuator suspension assembly is mounted with the head/slider thereon and is swung around a pivot shaft to position the head/slider to an appointed track of the plural tracks. A distance L1 between the center of the pivot shaft and the center of the spindle, a distance L2 between the center of the pivot shaft and the point P, and a pivot line Z which goes through the center of the pivot shaft and the point P are defined. The actuator suspension assembly is configured in such a manner that the reference line Y intersect the pivot line Z at a predetermined angle and the skew angle of the head/slider is made positive with respect to the rotary disk type recording medium at about 80% or more of all the plurality of tracks.

If the reference line Y intersects the pivot line Z at a given angle, the skew angle can be set to a specified value by making the respective centerlines X of the components, constituting the actuator head suspension assembly, not-align with each other. The actuator head suspension assembly has a flexure on which the head/slider is mounted, a load beam on which the flexure is mounted and an actuator arm on which the load beam is mounted. A percentage of all tracks by which the skew angle can be made positive can be set to a specific value by mounting one or more such components at appropriate angles with respect to the centerlines of those on which the components are mounted. Likewise, a percentage of all tracks by which the skew angle can be made positive by bending the flexure, load beam or actuator arm.

The actuator head suspension assembly comprises a head/slider, flexure, load beam, actuator arm and other components, and these components have the same centerline defined in the length direction. Mounting a component on another component at an angle means that their centerlines are not aligned with each other. Bending a component, such as a flexure, load beam or actuator arm, means that the component itself has two or more center lines or has a curved center line.

The magnitude of the skew angle should be as small as possible in view of the dependence of the head/slider flying height on the linear speed and the flying stability. The skew angle is smallest at the innermost track and becomes larger toward the outermost track. Thus, by setting the skew angle at the innermost track to zero, it is possible not only to make the skew angle positive at all tracks but also minimize the magnitude of the skew angle at the outermost track.

According to a third aspect of the present invention, there is provided, in a rotary disk storage device comprising: a rotary disk type recording medium which is rotatably held around a spindle and has a plurality of concentric tracks around the spindle; a head/slider composed of a slider having an air bearing surface and a head; and an actuator suspension assembly on which the head/slider is mounted, a method for preventing dust deposition on the air bearing surface of the head/slider. The method comprises configuring the actuator suspension assembly so as to make the skew angle of the head/slider positive or negative at about 80% or more of the plurality of tracks; rotating the rotary disk type recording medium; facing the air bearing surface of the head/slider toward the rotary disk type recording medium; and swinging the actuator suspension assembly to move the flying head/slider across some of the plurality of tracks on the surface of the rotary disk type recording medium.

The actuator suspension assembly can be configured so as to make the skew angle positive or negative at about 90% or more or 100% of all the tracks.

According to embodiments of the present invention, a rotary disk storage device which suppresses dust deposition on the air bearing surface of each head/slider is provided. A method for suppressing dust deposition on the air bearing surface of a head/slider, applicable to rotary disk storage devices, is also provided.

### BRIEF DESCRIPTION OF THE DRAWINGS

FIG. 1 schematically shows the configuration of a magnetic disk device according to an embodiment of the present invention;

FIG. 2 is a perspective view of the activator head suspension assembly (AHSA) 13 shown in FIG. 1;

FIG. 3 is a perspective view showing how the head suspension assembly (HSA) 29 shown in FIG. 1 and FIG. 2 is assembled;

FIG. 4 is a plan view of the flexure 45 shown in FIG. 3 as viewed from the magnetic disk side;

FIG. 5 a side view of the schematic structure of the flexure 45;

FIG. 6 includes diagrams illustrating how the head/slider has a skew angle;

FIG. 7 includes a perspective view and a plan view illustrating the air bearing surface of the head/slider shown in FIG. 3;

FIG. 8 is a diagram showing an embodiment of the present invention to make the skew angle positive;

FIG. 9 is a diagram showing another embodiment of the present invention to make the skew angle positive;

FIG. 10 is a view showing an embodiment of the present invention to mount a head/slider on a flexure at an angle;

FIG. 11 is a diagram showing an embodiment of the present invention to mount a load beam on an actuator arm at an angle;

FIG. 12 is a diagram showing an embodiment of the present invention to have a bent portion formed in an actuator arm;

FIG. 13 is a view showing an embodiment of the present invention to have a bent portion formed in an HSA;

FIG. 14 is a flowchart illustrating how the present invention is implemented to prevent dust deposition according to a specific embodiment.

### DETAILED DESCRIPTION OF THE INVENTION

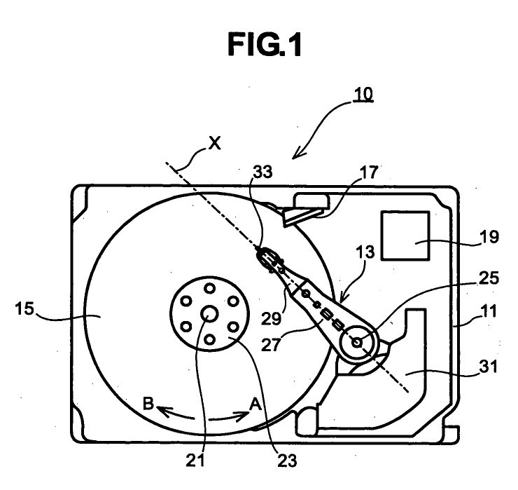

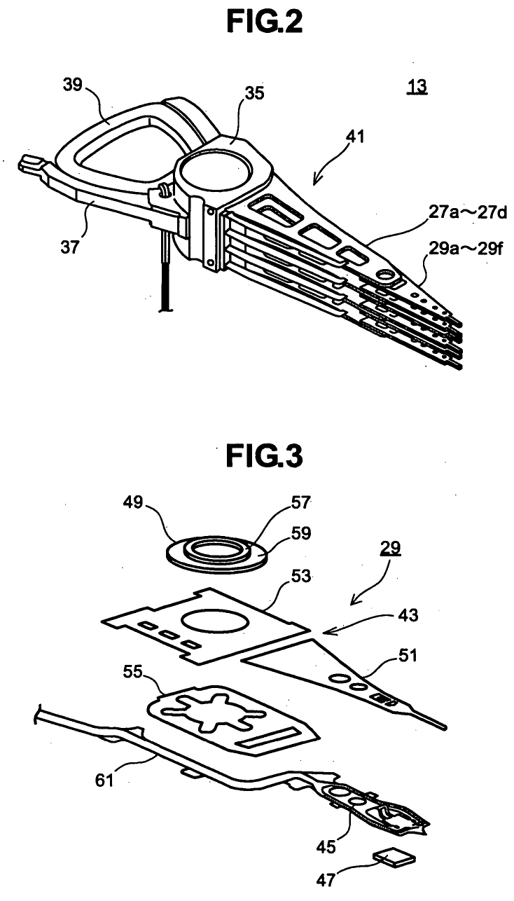

FIGS. 1 and 2 schematically depict a magnetic disk device 10 and an actuator head suspension assembly (hereinafter denoted as AHSA) 13. Throughout this specification, like components illustrated in each drawing are denoted by like reference numerals. A housing 11, with a housing cover (not shown) attached to its top, defines a sealed space in which an AHSA 13, a magnetic disk stack 15, ramps 17, semiconductor chips and others are accommodated to constitute a head disk assembly (hereinafter denoted as HDA).

The magnetic disk stack 15 has three disks stacked concentrically with their recording surfaces set parallel to each other. The disks are mounted to a spindle hub (not shown) and fixed by disk pressers 23 so that they are rotated as one by a spindle 21. The magnetic disk stack 15 may have either a single disk or a plurality of disks. Recording surface is formed on the top and bottom sides of each magnetic disk. Each recording surface has a plurality of concentric tracks formed continuously. This may also be arranged in such a manner that one of the stacked disks has a side on which only servo information is recorded.

The AHSA 13 is composed of an actuator assembly 41 and head suspension assemblies 29 (hereinafter denoted as HSAs). The actuator assembly 41 is composed of a pivot bearing 35, a coil support 37, a voice coil 39 and actuator arms 27a through 27d. Into the pivot bearing 35, a pivot shaft 25 supported at the bottom of the housing is inserted. Behind the pivot bearing 35, a voice control motor which comprises a voice coil 39 and a coil yoke 31 having a permanent magnet on its rear side is provided. The voice coil motor generates driving force to horizontally rotate the actuator assembly 41 around the pivot shaft 25.

The actuator mechanism which is composed of the actuator arms 27, pivot shaft 25, pivot bearing 35, coil support 37, voice coil 39 and coil yoke 31 is called a rotary type actuator or swing type actuator. Four actuator arms 27a through 27d are stacked in order to carry six HSA 29 sets. Since the magnetic disk stack 15 has three stacked disks and therefore has six recording surfaces, six HSA 29 sets are provided. Of the four stacked actuator arms 27a through 27d, one set of HSA 29 is attached to each of the top and bottom actuator arms 27a and 27d while two sets are attached to each of the two inner actuator arms 27b and 27c.

The HSA 29 is composed of a suspension assembly and a header/slider. The suspension assembly will be described with reference to FIG. 3. At the front end of each of the HSAs 29a through 29f, a tab 33 is formed (FIG. 1). When the rotating magnetic disks are stopped, the AHSA 13 lifts up and retracts each head/slider from the magnetic disk surface by letting the tab 33 slide on the saving surface of the ramp 17. In this embodiment, the magnetic disk stack 15 rotates from the pivot shaft 25 toward the tab 33 in the direction shown by an arrow A, that is, rotates forward, although the present embodiment can also be applied to a magnetic disk device in which the disks rotate reversely as shown by an arrow B. As shown in FIG. 1, the AHSA is assembled in such a manner that its centerline X in its longitudinal direction intersects the center of the pivot shaft 25 and is aligned with the centerline of the actuator arm 27 and that of the HSA 29.

FIG. 3 is a perspective view showing how the HSA 29 is assembled. Of those shown in FIGS. 1 and 2, only one set is representatively depicted. The HSA 29 is composed of a load beam 43 made of a thin stainless steel sheet, a flexure 45, a head/slider 47 and a mount plate 49. Although the load beam 43 is of the multi-piece type and has a beam piece 51, a base piece 53 and a hinge piece 55, this is not intended to limit the load beam to this type. The present embodiment can also employ 3-piece type and other known type load beams.

The hinge piece 55 has a spring function to give a negative pressure load to the head/slider 47 so as to act against the buoyancy received from flowing air generated by the rotating disk 15. The beam piece 51 provides rigidity to stably maintain the altitude of the flexure when the AHSA 13 is moved. The base piece 53 has strength to fix the load beam 43 to the actuator arm 27. The mount plate 49 has a circular boss 57 formed around the center and the flange 59 is bonded to the base piece 53 by spot welding or using an adhesive. With the flange 59 of the mount plate 49 located on a surface of the actuator arm 27, the boss 57 is inserted into the swage hole of the actuator arm and swaged for integration with the actuator arm.

The hinge piece 55 is bonded with the beam piece 51 and base piece 53 by spot welding or using an adhesive. The flexure 45 is fabricated by processing a laminate sheet by a known photolithographic etching technology. This laminate sheet comprises a stainless steel layer, a polyimide dielectric layer, a copper conductor layer and a polyimide protective layer in this order as viewed from the load beam side. Further, the flexure 45 is provided with a wiring layer 61 connected to the head/slider.

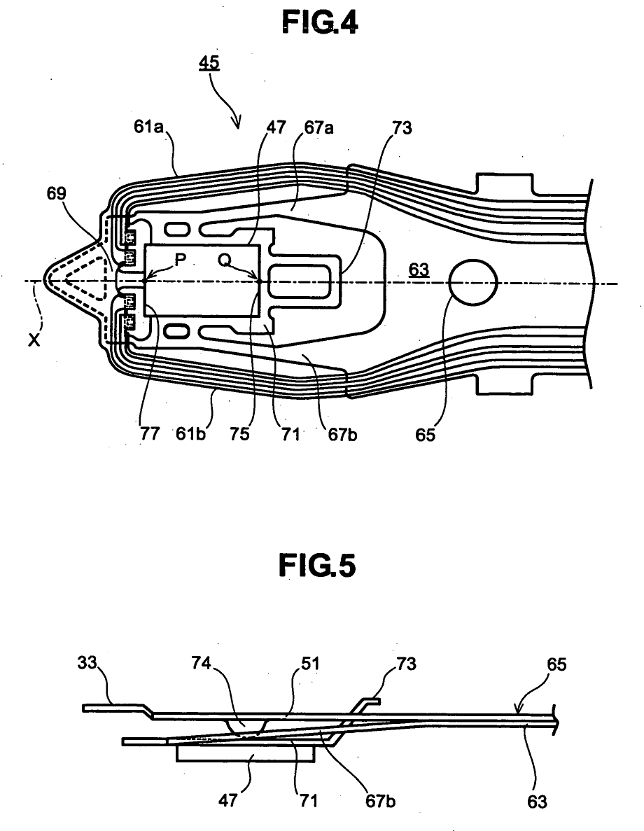

FIG. 4 is a plan view of the flexure 45 shown in FIG. 3. In this figure, the flexure 45 is viewed from the magnetic disk side. The flexure 45 is generally made of a thin stainless steel layer. A support area 63 is partly bonded to the load beam 43 at the support end by spot welding. From the support area 63, one pair of arms 67a and 67b extend to the front end of the load beam. In the front end area, these arms are joined. Further, the flexure 45 has a flexure tongue 71 formed so as to be held by the front end area 69 and arms 67a and 67b.

A dimple contact point (DCP) (not shown) is defined at or near the center of the flexure tongue 71 and the head/slider 47 is fixed with an adhesive so that the DCP comes at or near its center. The head/slider 47 is shaped into almost a rectangular parallelepiped and has a leading edge 75 (also called an air inflow end) on the air inflow side and a trailing edge 77 (also called an air outflow end) on the air outflow side.

The head/slider 47 is fixedly positioned so that the middle point P of the trailing edge 77 and the middle point Q of the leading edge 75 lie on the center line X of the flexure 47. That is, while AHSA 13 includes the heads/sliders 47, the flexures 45 to which the heads/sliders are attached, the load beams 43 to which the flexures are attached and the actuator arms 27 to which the load beams are attached, they are all aligned to the center line X which goes through the center of the pivot shaft.

In FIG. 4, the shape of the air bearing surface of the head/slider 47 is not illustrated. The wiring layers 61a and 61b connected to the wiring layer 61 are formed on the metal layers and, at the end of the support area, separated from the metal layers before terminated at positions aligned to the bonding pads formed on the head/slider 47. The flexure tongue 71 has a limiter 73 formed on the actuator arm side.

FIG. 5 is a schematic side view of the flexure 45 shown in FIG. 4. The flexure tongue 71 is held by a cantilever spring structure comprising the metallic support area 63 which is welded to the load beam 51 at the welding spot 65 and two arms 67a (hidden in FIG. 5) and 67b. The beam piece 51 of the load beam has a dimple 74 formed by press working. A DCP is formed by the dimple 74 which touches the head/slider 47 at or near the center of the head/slider mount surface to the flexure tongue 71. The head/slider 47, held by the flexure 45, flies over the recording surface of the magnetic disk to follow a track while pivoting flexibly around the dimple 74.

The head/slider 47 comprises a head or transducer performing reading and/or writing data and a slider, both of which are integrated with each other. The header and slider may be fabricated integrally. It is also possible to fabricate the head/slider 47 by fabricating a slider and then attaching a separately fabricated head to the slider. The slider, made of alumina titan carbide ceramics, is shaped into almost a rectangular parallelepiped having an air bearing surface formed by striking it with high speed ions. The slider to which the present embodiment is applied, however, may be made of any other known materials. In addition, the slider may be any of what are called a mini slider (100% slider), micro slider (70% slider), nano slider (50% slider), pico slider (30% slider) and femto slider (20% slider).

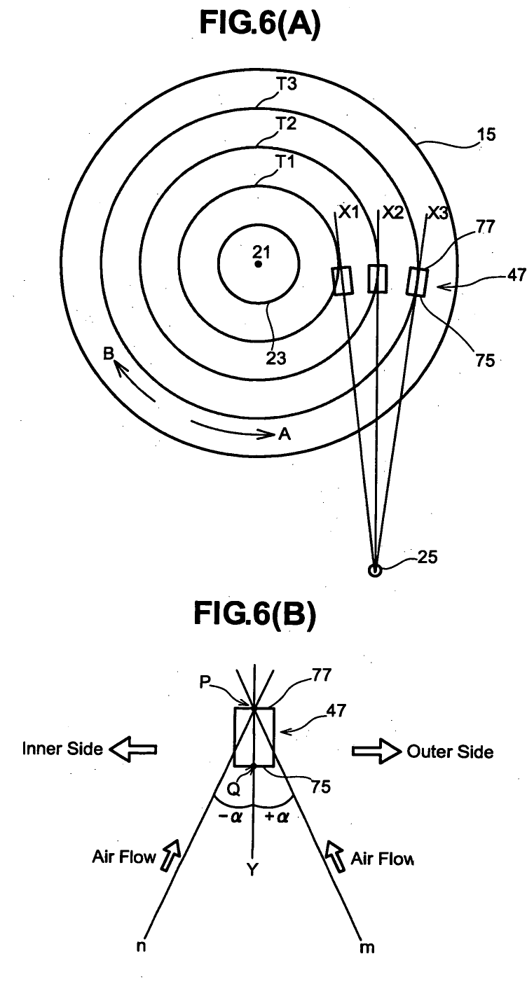

FIG. 6 is a diagram to assist in explaining the skew angle formed by the head/slider in the magnetic disk device described with reference to FIGS. 1 through 5. In FIG. 6(A), three tracks on the magnetic disk stack 15 are shown. From inner to outer, they are track T1, track T2 and track T3. For the purpose of explanation, the head/slider 47 is positioned to each of these tracks. Likewise, only one recording side of the magnetic disk is provided with the head/slider 47. FIG. 6(A) indicates that the AHSA 13 locates the head/slider 47 to tracks T1 through T3 by rotating its center line X to X1 through X3 around the pivot shaft 25.

Since the magnetic disk 15 is rotating in the direction shown by an arrow A (forward rotation), air on the surface of the magnetic disk flows along each circular track in the direction shown by the arrow A. Air flows into the opening between the recording surface of the head/slider 47 and the air bearing surface of the head/slider 47 from the leading edge 75 of the head/slider and flows out from the trailing edge 77. Air moves along the surface of the rotating magnetic disk. Thus, if the head/slider 47 is located to a certain track, the direction of air moving through the head/slider 47 is lined up with the tangent of the track drawn at the point where the head/slider 47 located.

In FIG. 6(A), assume that when the head/slider 47 is located to track T2, the AHSA's center line forms an angle of 0 with the tangent of track T2, i.e., the two lines are parallel to each other. Accordingly, air flows in perpendicularly to the leading edge 75 of the head slider 47 when the head/slider 47 is located at track T2. If the head/slider 47 is located at track T1 or track T3, air flows in not perpendicularly to the leading edge since the length from the center of the pivot shaft 25 to the head/slider 47 is fixed.

The following describes the skew angle with reference to FIG. 6(B). A head/slider whose air bearing surface is parallel with the recording surface of the magnetic disk is viewed perpendicularly from the magnetic disk side. A line (hereinafter denoted as reference line Y) assumed perpendicular to the leading edge intersects the trailing edge at point P. The skew angle means the angle a formed at point P between the reference line Y of the head/slider 47 and the tangent of the track. Thus, the skew angle changes depending on the track to which the head/slider is located. Since the head/slider is a rectangular parallelepiped, the reference line Y is parallel with the sides of the head/slider.

In FIG. 6, the intersection point P is depicted as the middle point of the trailing edge 77 although the intersection point P may also be a point where the reference line Y of the head intersects the trailing edge. Further, if there are two heads, the intersection point P may be a point where the reference line Y which is equally distant from the heads intersects the trailing edge.

The following describes the sign of the skew angle with reference to FIG. 6(B). FIG. 6(B) shows how the reference line Y of the head/slider 47 intersects the respective tangents m and n of tracks T3 and T1 at intersection point P. The skew angle is depicted as the angle α formed between the reference line Y and the tangent m or n.

If the AHSA is now aligned with the center line X3 to access track T3 by the head/slider 47, the tangent of track T3 is m relative to the reference line Y of the head/slider 47. Since the tangent of each track agrees with the air flow direction on the track, the leading edge 75 is pointed toward the inner track side relative to m. This skew angle is assumed as positive, i.e., +α.

Similarly, if the AHSA is aligned with the centerline X1 to access track T1 by the head/slider 47, the tangent of track T1 is n relative to the reference line Y of the head/slider 47. The leading edge 75 is pointed toward the outer track side relative to n. In this case, the skew angle is assumed as negative. If the AHSA is aligned with the centerline X2 to access track T2 by the head/slider 47, the reference line Y agrees with the tangent, causing a skew angle of zero.

The above description is made on the assumption that the magnetic disk is rotating forward. If the magnetic disk stack 15 is rotating reversely as shown by the arrow B in FIG. 6(a), the leading edge and trailing edge of the head/slider are positioned reversely as compared with the one designed for forward rotation. In this case, the skew is assumed as positive if the oppositely positioned leading edge is pointed toward the outer side relative to the tangent of the track and negative if the leading edge is pointed toward the inner side relative to the tangent of the track.

The changing skew angle changes the buoyancy acting on the air bearing surface and therefore changes the flying height of the head/slider. To solve this problem by making the magnitude of the skew angle as small as possible, AHSAs in conventional magnetic devices are configured in such a manner that the head/slider has both positive and negative skew angles.

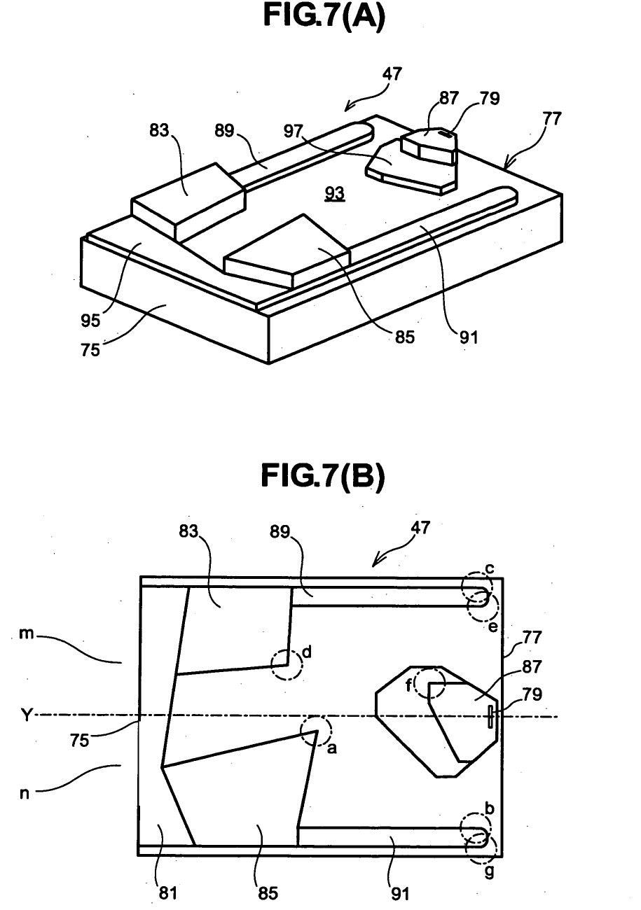

FIG. 7 provides a perspective view and plan view of the head/slider 47 shown in FIG. 3. Its air bearing surface is viewed from the side of the recording surface of the magnetic disk. The air bearing surface has a front step 95, front pads 83 and 85, side rails 89 and 91, a center pad 87 and a center step 97 which are formed in a recessed flat area 93. The center pad 87 is provided with a head 79 formed thereon. To eliminate the dependence of the flying height of the head/slider on the skew angle and on the linear velocity changed due to the circumferential velocity of the track, the air bearing surface is made asymmetrical with respect to the center line and the pads and rails are shaped sophistically.

Since the front pads 83, 85 and center pad 87 are near to the recording surface of the magnetic disk, they receive a flow of air and therefore generate a positive dynamic pressure to give buoyancy to the head/slider. The recessed flat area 93 functions as a negative pressure generating portion which generates a negative dynamic pressure since the air which has passed the front step 95 expands in the recessed flat area 93. The negative dynamic pressure, combined with the pressing force by the load beam, improves the flying performance of the head/slider. If a slider whose air bearing surface has such a negative pressure generating portion as the recessed flat area shown in shown in FIG. 7, the slider is called a negative pressure slider.

The negative slider shown in FIG. 7 is also classified as a center pad type slider although the present embodiment can also be applied to not only other negative pressure sliders such as center rail type and two-rail type sliders described in Japanese Patent Laid-open No. 2001-155319 but also positive pressure sliders such as the catamaran type which has only two rails with no negative pressure generating portion. However, the present embodiment is particularly effective to head sliders which have structurally complicated air bearing surfaces likely to cause air staying and dust deposition.

The air bearing surface is designed so that when it is allowed to face onto the surface of the rotating magnetic disk, the leading edge 75 rises higher from the magnetic disk surface than the trailing edge 77. Air flows into the opening between the air bearing surface and the magnetic disk surface from the leading edge and passes the front step 95. After the front step 95, parts of this air stream concurrently flow along the surfaces of the front pads 83 and 85 and along the recessed flat area 93. Further, part of the air stream flows along the surface of the center pad 87. As described earlier, the air stream which goes through the air bearing surface contains dust although its amount is very small.

The inventors of the present invention observed the deposition of dust on the air bearing surface and found that dust deposition occurred remarkably in places pointed out by a through g in FIG. 7(B). Further, through close observation we found that accumulation remarkably advanced in places a through c when air was flowing in along the tangent m of the track at a positive skew angle while accumulation advanced in places d through g when air was flowing in along the tangent n of the track at a negative skew angle. It seems that these places behind pads and rails are likely to reduce the speed of air if the head/slider has a skew angle, i.e., air flows in not perpendicularly to the leading edge.

Further, the inventors of the present invention have clarified the reason that accumulated dust deposits there without being removed by the subsequent air flow. The reason is as follows. Dust accumulation advances in places a through c when air is flowing in at a positive skew angle. Then, if the head/slider is swung to make the skew angle negative, the accumulated dust is pressed against the pads and rails by the air which is flowing in at a negative skew angle. Combined with the effect of the viscous component of the lubricant, this pressing causes the accumulated dust to deposit there. When air is flowing in at a negative skew angle, dust accumulation advances in places d through g. Likewise, deposition in these places occurs when air is flowing in at a positive skew angle since the inflow air acts to press the dust there.

The deposited dust particles change the shape of the air bearing surface and therefore deteriorate the flying performance of the head/slider. Unfavorably, this may deteriorate the recording/reproducing performance and cause the head/slider to touch the recording surface of the magnetic disk. Since the deposition of dust particles was found attributable to the skew angle which varied from a negative angle to a positive angle, we constructed the AHSA 13 so as to make the skew angle always positive and conducted an experiment with it. The result has verified that this can reduce the amount of dust deposition. Making the skew angle always negative can attain a similar effect according to the same theory.

The following describes an embodiment of the present invention to make the skew angle of the head/slider always positive in the magnetic disk device 10. In FIG. 6, the line drawn through the center of the pivot shaft 25 and the intersection point P of the trailing edge is aligned with the center line X of the AHSA and the reference line Y of the head/slider 47. In many magnetic disk devices, the components of each AHSA, such as heads/sliders, flexures, load beams and actuator arms, lie on the single center line X. As understood from FIG. 6, one method for making the skew angle positive at any position of the recording surface is to make longer the distance between the center of the pivot shaft and the intersection point P of the trailing edge of the head/slider 47.

If the distance is made too long, however, the HSA 29 may interfere with the disk presser when the track to be accessed is near the innermost track. In addition, making the distance too long may excessively enlarge the magnitude of the skew angle, resulting in the deteriorated flying performance. These conditions determine the upper limit of the length. However, what is important in the present embodiment is the shortest distance between the center of the pivot shaft 25 and the intersection point P of the trailing edge which makes the skew angle positive at all tracks.

By further observing FIG. 6, it is also understood that as the head/slider 47 moves from track T1 to track T3, the skew angle changes toward a larger positive angle. Therefore, if the skew angle is zero at the innermost track, the skew angle is always positive at any outer track. Making the skew angle zero at the innermost track is desirable since not only the skew angle can be positive at every track but also the magnitude of the skew angle at the outermost track can be minimized.

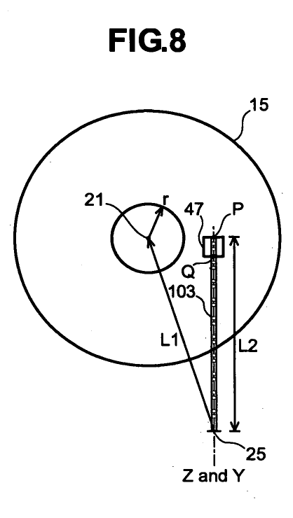

FIG. 8 shows an embodiment of the present invention to make the skew angle positive. The innermost track of the magnetic disk stack 15 has a radius r around the spindle 21. Radius r is 13.9 mm for the 2.5-inch magnetic disk and 18.0 mm for the 3.5-inch magnetic disk. What is obtained by removing the head/slider 47 from the AHSA 13 described with FIG. 1 is here called an actuator suspension assembly (ASA). The ASA comprises the actuator assembly 41 (see FIG. 2), load beam 43 (see FIG. 3) and flexure 45 (see FIG. 4). To simplify the description, the head/slider 47 is depicted in FIG. 8 as if it were held by the ASA represented schematically by lines 103.

L1 is the distance between the center of the pivot shaft 25 and the center of the spindle 21. The reference line Y of the head/slider intersects the trailing edge at the intersection point P. L2 is the distance between the center of the pivot shaft 25 and the intersection point P. Here, the ASA 103 lies on a line Z (hereinafter denoted as pivot line Z), which is drawn through the pivot shaft 25 and the intersection point P of the head/slider, and the reference line Y of the head/slider is aligned with the pivot line Z. Under this condition, the value of length L1 which makes the skew angle a positive at any track is formularized by Expression 1:
L₂²≧L₁²−r² [Expression 1]

For Expression 1 to be appropriate, the pivot line Z must be aligned with the reference line Y of the head/slider 47 but not with the centerline X of the AHSA 13. That is, as far as the pivot line Z is aligned with the reference line Y, Expression 1 is effective even if the AHSA 13 has a curbed or bent portion and its centerline X does not lie along the pivot line Z. For generally used magnetic disks, distance L2 makes the skew angle positive at all tracks if L2>0.94L1 is satisfied.

As mentioned above, if the reference line Y is aligned with the pivot line Z, the skew angle can be made positive at all tracks by setting the distance L2 so as to satisfy the condition cited above. If the distance L2 is decreased from the shortest distance satisfying the above condition, this makes the skew angle negative at the innermost one or more tracks. Therefore, by setting the distance L2 appropriately, it is freely possible to make the skew angle positive at, for example, about 80 to 90% of the all tracks and negative at the remaining tracks.

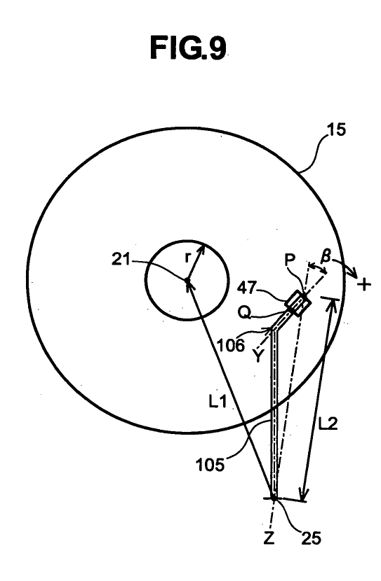

With reference to FIG. 9, the following describes another embodiment to make the skew angle positive. FIG. 9 is the same as FIG. 1 except that the head/slider 47 is held by a bent ASA 105. Since the ASA 105 is bent at a position 106, the pivot line Z is not aligned with the reference line Y of the head/slider 47. These lines intersect at an angle β. In this case, the skew angle is positive at all tracks if Expression 2 is satisfied, where L1 is the distance between the center of the pivot shaft 25 and the center of the spindle 21, L2 is the distance between the center of the pivot shaft 25 and the intersection point P of the trailing edge, r is the radius of the innermost track, and β is the angle between the reference line Y and the pivot line Z.
π/2-cos⁻¹{(r²+L₂²−L₁²)/2rL₂}≧−β [Expression 2]

Assume that the reference line Y intersects the pivot line Z at a given angle of y. If the angle γ is made smaller than the angle β, this makes the skew angle negative at the innermost one or more tracks. Therefore, by setting the angle γ appropriately, it is freely possible to make the skew angle positive at, for example, about 80 to 90% of the all tracks and negative at the remaining tracks.

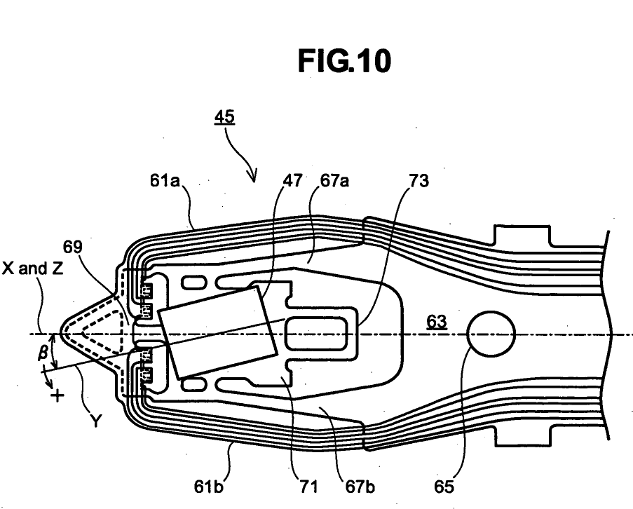

FIG. 10 shows an embodiment of the present invention in which the head/slider 47 is attached to the flexure 45 at such an angle that Expression 2 is satisfied to make the skew angle positive at all tracks. In FIG. 10, the ASA of the actuator assembly 41 comprises a load beam 27 and flexure 45 an its centerline X is aligned with the pivot line Z as shown in FIGS. 1 through 3. However, the header/slider 47 is mounted on the flexure tongue 71 in such a manner that the reference line Y intersects the pivot line Z at an angle of β. Since the head/slider 47 is fixed to the flexure tongue 71 with adhesive as mentioned earlier, the angle β between the reference line Y and the pivot line Z can be set to a predetermined appropriate angle. By setting a angle smaller than P min, it is also possible to make the skew angle negative at, for example, about 10 to 20% of the all tracks.

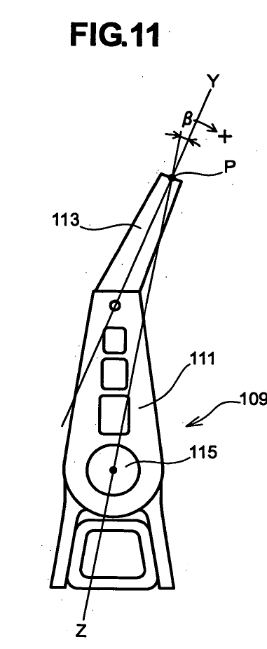

FIG. 11 shows another embodiment of the present invention to satisfy Expression 2 so that the skew angle is made positive at all tracks. The AHSA 109 is the same in configuration as that shown in FIGS. 2 and 3 except that the HSA 113 is mounted to the swage portion of the actuator arm 111 at an angle. Using the mount plate 49 shown in FIG. 3, the load beam which is a component of the HSA 113 is mounted to the actuator arm 111 at an angle. The center of the AHSA 109 does not form a single centerline. The centerline of the actuator arm 111 is not aligned with the centerline of the load beam and flexure. These centerlines intersect at an angle. In the case of FIG. 11, the centerline of the load beam and flexure is aligned with the reference line Y of the head/slider. Therefore, the AHSA 109 can be configured in such a manner that the reference line Y intersects the pivot line Z at an angle β. By setting the angle smaller than β, it is also possible to make the skew angle negative at some tracks.

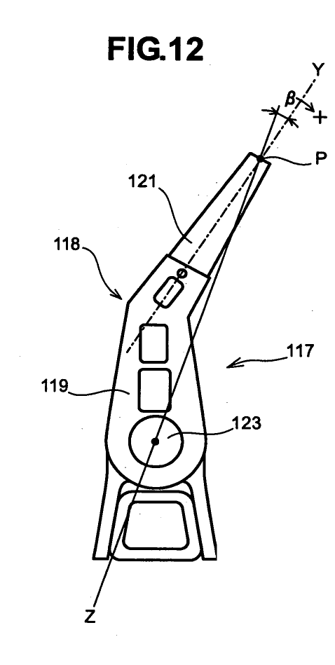

FIG. 12 shows yet another embodiment to satisfy Expression 2 so that the skew angle is made positive at all tracks. The actuator arm 119 of the AHSA 117 has a bent portion 118. In this embodiment, the AHSA 117 has the bent portion 118 formed between the front end and support end thereof. Its centerline at the front end is aligned with the centerline of the HSA 121. The centerline of the HSA 121 is also aligned with the reference line Y. Therefore, the AHSA 117 can be configured in such a manner that the reference line Y intersects the pivot line Z at angle β. By setting the angle smaller than β, it is also possible to make the skew angle negative at some tracks. Instead of the bent portion 118, this embodiment may also be modified so as to curve the whole actuator arm 119 or form a plurality of bent portions.

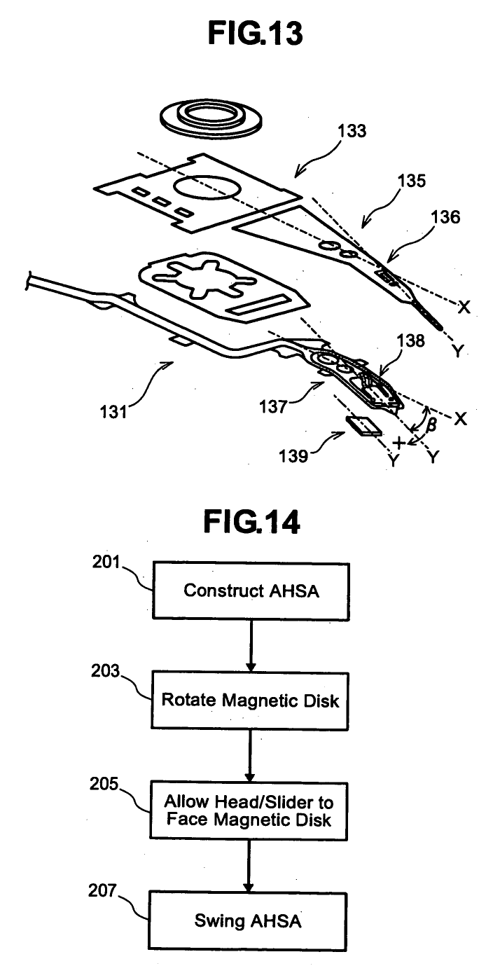

FIG. 13 shows still another embodiment to satisfy Expression 2 so that the skew angle is made positive at all tracks by adding a bent portion to the HSA shown in FIG. 3. The beam piece 135 of the load beam and the flexure 137 have bent portions 136 and 138, respectively, allowing the AHSA to be configured in such a manner that the reference line Y intersects the pivot line Z at the angle β. The bent portions 136 and 138 can also be configured so as to set the angle smaller than the angle β. In addition, this embodiment may be modified in such a manner that only one of the load beam and flexure has a bent portion.

From the embodiments shown in FIG. 10 through FIG. 13, it is apparent to those skilled in the art that the AHSA can be configured in other various modes so as to form the angle β to satisfy the Expression 2, or set the angle smaller than the angle β. For example, the angle of the flexure 45, shown in FIG. 4, mounted on the load beam 43 can be adjusted by the welding spot 65. In addition, a plurality of methods can be combined appropriately according to some of the manufacturing conditions and characteristics of the AHSA. Further, although FIG. 10 through FIG. 13 have been described as embodiments to satisfy Expression 2 so that the skew angle is made positive, it is apparent to those skilled in the art that the skew angle can be made negative by reversing the bending direction.

Specific embodiments of the present invention have been described on the assumption that the head/slider is a flying type head slider expected to normally fly over the magnetic disk surface. Aimed at a higher recording density, however, the flying height tends to become still lower. There have appeared not only a head/slider supposed to touch the magnetic disk at a certain frequency but also a contact recording type head/slider whose trailing edge is normally kept in contact with the magnetic disk surface. The present invention is effective in any head/slider whose behavior may deteriorate due to dust particles deposited on the air bearing surface. The scope of the present invention is not limited to heads/sliders which are expected to completely fly during normal operation.

The present invention exhibits effect not only when the skew angle is made positive or negative at all tracks but also when the skew angle is made positive or negative at some percentage of the tracks at least. For the present invention to exhibit effect, the skew angle of the head/slider is made positive or negative preferably at about 80% or more, more preferably at about 90% or more or most preferably at 100% of all the tracks.

With reference to the flowchart of FIG. 14, the following describes how a specific embodiment of the present invention is implemented to prevent dust particles from depositing on the air bearing surface of the head/slider in the magnetic disk device shown in FIGS. 1 through 5. In block 201, the AHSA 13 is constructed according to the skew angle. The skew angle may be set positive or negative at, for example, 80%, 90% or 100% of all tracks. This can be realized by constructing the AHSA 13 in any of the methods described with reference to FIGS. 10 through 14.

In block 203, the magnetic disk stack is rotated. In block 205, the head/slider 47 faced toward the magnetic disk flies since the air bearing surface receives flowing air generated on the recording surface of the rotating magnetic disk. In block 207, the AHSA is swung. While the AHSA is swung across all tracks, the skew angle of the head/slider is dominantly positive or negative. Therefore, although the inflow air contains dust particles, their deposition on the air bearing surface is suppressed since air does not stay on the air bearing surface.

Although the present invention has so far been described with reference to particular embodiments, the scope of the present invention is not limited to thee embodiments. It is apparent that the present invention can be employed in any known structure to which the present invention provides effect.

The present invention can be applied to magnetic disk devices, optomagnetic disk devices and other head/slider-equipped rotary disk storage devices in general.

1. A rotary disk storage device comprising:
a rotary disk type recording medium which is rotatably held around a spindle and has a plurality of concentric tracks around the spindle;
a head/slider including a slider and a head, the slider having a leading edge; a trailing edge; and an air bearing surface; wherein a reference line Y perpendicular to the leading edge and a point P where the reference line Y intersects the trailing edge are defined; and
an actuator suspension assembly which is mounted with the head/slider thereon and is swung around a pivot shaft to position the head/slider to an appointed track of the plurality of tracks,
wherein a distance L1 between the center of the pivot shaft and the center of the spindle and a distance L2 between the center of the pivot shaft and the point P are defined; and
wherein the actuator suspension assembly is configured so as to make a skew angle of the head/slider positive with respect to the rotary disk type recording medium at about 80% or more of all the plurality of tracks, the skew angle being defined between the reference line Y and a tangent of the appointed track.

2. A rotary disk storage device according to claim 1, wherein the actuator suspension assembly is configured in such a manner that the reference line Y is aligned with a pivot line Z defined so as to go through the point P and the center of the pivot shaft and the distance L2 is set so as to make the skew angle positive at about 90% or more of all the plurality of tracks.

3. A rotary disk storage device according to claim 1, wherein the actuator suspension assembly is configured in such a manner that the reference line Y is aligned with a pivot line Z defined so as to go through the point P and the center of the pivot shaft and the distance L2 is set so as to make the skew angle positive at all the plurality of tracks.

4. A rotary disk storage device according to claim 3, wherein the actuator suspension assembly is configured so that the distance L1, the distance L2 and the radius r of the innermost one of the plurality of tracks have the following relation:
L₂²≧=L₁²−r².

5. A rotary disk storage device according to claim 3 wherein the actuator suspension assembly is configured in such a manner that the distance L2 is at least about 0.94 times as long as the distance L1.

6. A rotary disk storage device comprising:
a rotary disk type recording medium which is rotatably held around a spindle and has a plurality of concentric tracks around the spindle;
a head/slider including a slider and a head, the slider having a leading edge; a trailing edge; and an air bearing surface; wherein a reference line Y perpendicular to the leading edge and a point P where the reference line Y intersects the trailing edge are defined; and
an actuator suspension assembly which is mounted with the head/slider thereon and is swung around a pivot shaft to position the head/slider to an appointed track of the plural tracks;
wherein a distance L1 between the center of the pivot shaft and the center of the spindle, a distance L2 between the center of the pivot shaft and the point P, and a pivot line Z which goes through the center of the pivot shaft and the point P are defined; and
wherein the actuator suspension assembly is configured in such a manner that the reference line Y intersect the pivot line Z at a predetermined angle and a skew angle of the head/slider is made positive with respect to the rotary disk type recording medium at about 80% or more of all the plurality of tracks, the skew angle being defined between the reference line Y and a tangent of the appointed track.

7. A rotary disk storage device according to claim 6, wherein the actuator suspension assembly is configured so as to make the skew angle positive at all the plurality of tracks.

8. A rotary disk storage device according to claim 6, wherein the actuator suspension assembly includes a flexure and the head/slider is mounted on the flexure at an angle.

9. A rotary disk storage device according to claim 6, wherein the actuator suspension assembly includes a flexure having the head/slider mounted thereon and the flexure has a bent portion.

10. A rotary disk storage device according to claim 6, wherein the actuator suspension assembly includes a flexure and a load beam and the flexure is mounted on the load beam at an angle.

11. A rotary disk storage device according to claim 6, wherein the actuator suspension assembly includes a load beam and the load beam has a bent portion.

12. A rotary disk storage device according to claim 6, wherein the actuator suspension assembly includes a load beam and an actuator arm and the load beam is mounted on the actuator arm at an angle.

13. A rotary disk storage device according to claim 6, wherein the actuator suspension assembly includes an actuator arm and the actuator arm has a bent portion.

14. A rotary disk storage device according to claim 6, wherein the actuator suspension assembly includes:
a flexure on which the head/slider is mounted;
a load beam on which the flexure is mounted; and
an actuator arm on which the load beam is mounted; and
wherein a combination of two or more of the following measures is employed:
mounting the head/slider on the flexure at an angle;
forming a bent portion in the flexure;
mounting the flexure on the load beam at an angle;
forming a bent portion in the load beam;
mounting the load beam on the actuator arm at an angle; and
forming a bent portion in the actuator arm.

15. A rotary disk storage device according to claim 6, wherein the actuator suspension assembly is configured so as to make the skew angle positive at all the plurality of tracks.

16. A rotary disk storage device according to claim 15, wherein the actuator suspension assembly is configured in such a manner that the reference line Y intersects the pivot line Z at an angle β and the following relational expression holds among the angle β, the distance L1, the distance L2 and the radius r of the innermost one of the plurality of tracks:
π/2-cos⁻¹{(r²+L₂²−L₁²)/2rL₂}≧−β.

17. A rotary disk storage device according to claim 16, wherein the actuator suspension assembly includes a flexure and the head/slider is mounted on the flexure at such an angle that the reference line Y intersects the pivot line Z at the angle β.

18. A rotary disk storage device according to claim 16, wherein the actuator suspension assembly includes a flexure on which the head/assembly is mounted and the flexure has such a bent portion that the reference line Y intersects the pivot line Z at the angle β.

19. A rotary disk storage device according to claim 16, wherein the actuator suspension assembly includes a load beam and a flexure is mounted on the load beam at such an angle that the reference line Y intersects the pivot line Z at the angle β.

20. A rotary disk storage device according to claim 16, wherein the actuator suspension assembly includes a load beam on which a flexure is mounted and the load beam has such a bent portion that the reference line Y intersects the pivot line Z at the angle β.

21. A rotary disk storage device according to claim 16, wherein the actuator suspension assembly includes an actuator arm and a load beam is mounted on the actuator arm at such an angle that the reference line Y intersects the pivot line Z at the angle β.

22. A rotary disk storage device according to claim 16, wherein the actuator suspension assembly includes an actuator arm on which a load beam is mounted and the actuator arm has such a bent portion that the reference line Y intersects the pivot line Z at the angle β.

23. A rotary disk storage device according to claim 6, wherein the actuator suspension assembly includes:
a flexure on which the head/slider is mounted;
a load beam on which the flexure is mounted; and
an actuator arm on which the load beam is mounted; and
wherein a combination of two or more of the following measures is employed so that the reference line Y intersects the pivot line Z at the angle β:
mounting the head/slider on the flexure at an angle;
forming a bent portion in the flexure;
mounting the flexure on the load beam at an angle;
forming a bent portion in the load beam;
mounting the load beam on the actuator arm at an angle; and
forming a bent portion in the actuator arm.

24. A rotary disk storage device according to any one of claims 1, 6, and 14 wherein the reference line Y goes through the middle point of the trailing edge.

25. A rotary disk storage device according to any one of claims 1, 6, and 14 wherein the head/slider is a negative slider having a negative pressure generating portion.

26. A rotary disk storage device according to any one of claims 1, 6, and 14 wherein the rotary disk type recording medium rotates reversely.

27. In a rotary disk storage device comprising: a rotary disk type recording medium which is rotatably held around a spindle and has a plurality of concentric tracks around the spindle; a head/slider composed of a slider having an air bearing surface and a head; and an actuator suspension assembly on which the head/slider is mounted, a method for preventing dust deposition on the air bearing surface of the head/slider, the method comprising:
configuring the actuator suspension assembly so as to make a skew angle of the head/slider positive or negative at about 80% or more of the plurality of tracks, the skew angle being defined between a reference line Y and a tangent of a track to which the head/slider is to be located, the reference line Y being perpendicular to a leading edge of the head/slider;
rotating the rotary disk type recording medium;
facing the air bearing surface of the head/slider toward the rotary disk type recording medium; and
swinging the actuator suspension assembly to move the flying head/slider across some of the plurality of tracks on the surface of the rotary disk type recording medium.

28. A method according to claim 27, wherein in configuring the actuator suspension assembly, the actuator suspension assembly is configured so as to make the skew angle of the head/slider positive or negative at all the plural tracks.
